(19) United States
(12) Patent Application Publication
(10) Pub. No.: US 2016/0294942 A1
(43) Pub. Date: Oct. 6, 2016

(54) Synchronization on Gateways for Connected Mobile Applications

(71) Applicant: QUALCOMM Incorporated, San Diego, CA (US)

(72) Inventors: Priyanka Tembey, Mountain View, CA (US); Saumitra Mohan Das, Santa Clara, CA (US); Dilma Da Silva, San Jose, CA (US); Vrajesh Bhavsar, Sunnyvale, CA (US)

(21) Appl. No.: 14/673,758

(22) Filed: Mar. 30, 2015

(51) Int. Cl. H04L 29/08; H04L 29/06

(52) U.S. Cl. CPC H04L 67/1095; H04L 67/42; H04L 65/102

(57) ABSTRACT

Mobile devices or other client devices generally support applications that provide content to users. Application-related data transfer represents a significant portion of client device bandwidth usage. As client devices are frequently within the range of gateways (e.g., WiFi routers), the gateways may assist with application data transfer. Through application-sensitive and proactive data transfer strategies, the gateways may improve user experience and power consumption on the client devices. Disclosed are systems and methods for synchronizing application content between client devices and application servers through gateways.

### BACKGROUND

1. Field of the Disclosure

The present application generally relates to networking technology and, more specifically, to systems and methods for transferring of application content to and from mobile devices and other client devices connected to gateways.

2. Description of Related Art

With the proliferation of mobile devices in the consumer marketplace, mobile data usage places an ever-increasing demand on cellular networks. Data transfer also consumes power on the mobile devices, which reduces battery life. Mobile applications are a significant cause of mobile data usage. In fact, many if not all of the most popular mobile applications (e.g., Facebook, Twitter, YouTube) communicate with cloud services to deliver dynamically updated content (e.g., user-specific newsfeeds) to users.

A mobile device user generally spends much of their time in a limited number of locations such as their home and workplace. These facilities are often supported by gateways (e.g., customer edge routers) that can provide alternative network connections for mobile devices, which can reduce load on the cellular networks. The gateways further help mobile device users remain within provider-imposed limits on cellular network usage (e.g., monthly bandwidth caps).

### SUMMARY

Disclosed are systems and methods for using gateways to synchronize application content on mobile devices and other client devices. Application agents may be installed on a gateway, such as a customer edge router, within a facility. The application agents may receive one or more users' authentication information and other application credentials from corresponding mobile applications on the users' mobile or other client devices. The application agents may then request user-specific content from cloud services autonomously from the client devices. The application agents may, for example, use the same data-transfer application programming interfaces (API) that are used by mobile applications to communicate with application servers. The gateway may then receive and cache application content from the application servers in application data storage.

If the user uses an application on the client device when the client device is in range of the gateway, download and upload requests may be analyzed by the gateway. When processing a download request (e.g., for a user-specific newsfeed), the gateway may first check the cached content. If the requested data is not cached, the gateway may notify the application that the gateway plans to download the data, allowing the client device to switch its modem to a low-power mode. Then, when the data is fully downloaded and cached, the gateway may alert the client device that the download is ready. This reduces the duration of the data transfer to the client device (e.g., reducing power consumption by reducing the amount of time a client mobile device's modem is in a high-power mode).

During an upload process, the client device may upload the desired content fully to the gateway and the gateway may separately upload the content to the cloud. In both the upload and download scenarios, the client device's modem may be in a high-power mode for a relatively shorter time than is conventional, which beneficially saves power on the client device and leads to more energy efficient data transfer.

The gateway's autonomous requests to the application servers may be made during times that may improve user experience (e.g., before the user is expected to request the content on their mobile device) and/or times that are optimal for connecting to the application servers (e.g., when the servers have reduced loads and thus more available bandwidth). In some scenarios, the gateway may also push content (e.g., newsfeeds) to the client device before a user specifically requests the content, so that the content may be cached at the client device. For example, the gateway may send content to the client device after determining that the client device has a strong connection with the gateway. Proactively pushing content to be cached on the client device can decrease transmission times and thus power consumption at the client device. Additionally, user experience may improve as users can rapidly receive requested content that is locally cached on their mobile devices or other client devices.

### BRIEF DESCRIPTION OF DRAWINGS

Features, aspects, and embodiments of the disclosure are described in conjunction with the attached drawings, in which:

FIG. 1A shows a schematic diagram illustrating a system for synchronizing and providing application content;

FIG. 1B shows a schematic diagram illustrating the system of FIG. 1A in more detail;

FIG. 2 shows a flowchart illustrating an exemplary process for prefetching application content to be cached on a gateway;

FIG. 3 shows a flowchart illustrating an exemplary process for managing download requests from a client device at a gateway; and

FIG. 4 shows a flowchart illustrating an exemplary process for managing upload requests from a client device at a gateway.

These exemplary figures and embodiments are to provide a written, detailed description of the subject matter set forth by any claims in the present application. These exemplary figures and embodiments should not be used to limit the scope of any such claims.

Further, although similar reference numerals may be used to refer to similar structures for convenience, each of the various example embodiments may be considered to be distinct variations. When similar reference numerals are used, a description of the common elements may not be repeated, as the functionality of these elements may be the same or similar between embodiments. In addition, the figures are not to scale unless explicitly indicated otherwise.

### DETAILED DESCRIPTION

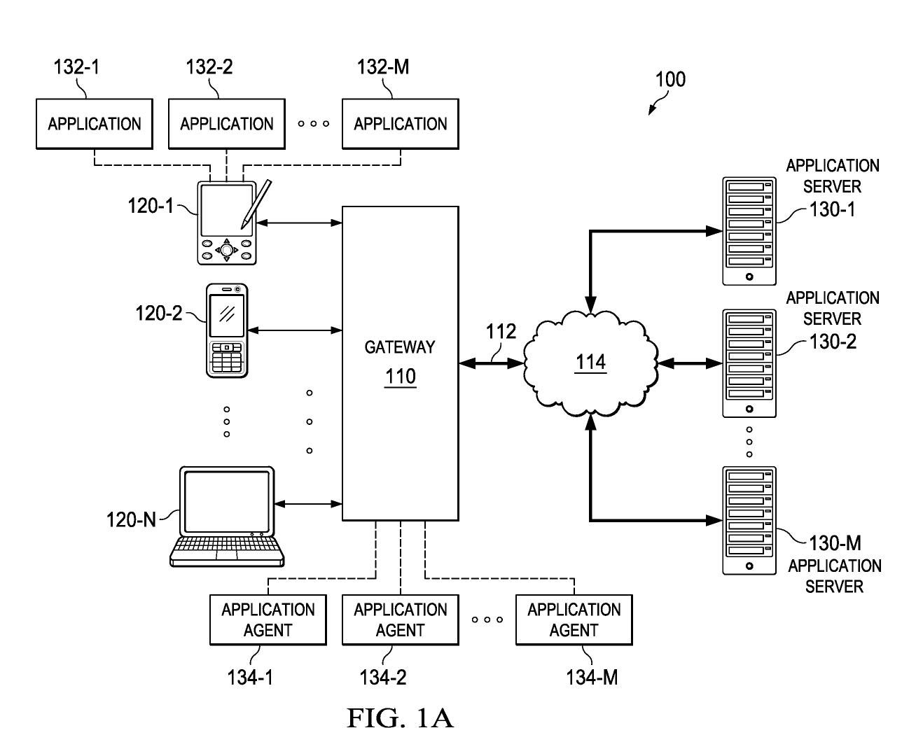

FIG. 1A shows a schematic diagram illustrating a system 100 for synchronizing and providing application content. The system 100 may comprise a plurality of mobile devices or other client devices 120-1 through 120-N (collectively or singularly “120”) that connect through a gateway 110 to a remote network 114 (e.g., the internet 114). The client devices 120 may service one or more users within a household, enterprise establishment, or other facility in which the gateway 110 may also be located. The client devices 120 may, for example, comprise tablets, laptop computers, mobile phones, smart home appliances, and other devices.

One or more applications 132 may be pre-installed on the client devices 120 or installed by the users at a later time. As shown in FIG. 1A, a plurality of applications 132-1 through 132-M (collectively or singularly “132”) may be supported and installed upon the client device 120-1. More, fewer, or different applications 132 may be installed on the other client devices 120-2 through 120-N.

The applications 132 may provide application content that may be tailored for particular users of the client devices 120. For example, a social networking application 132 may provide periodic, semi-periodic, or even real-time updates about a user's friends and social groups through one or more user-specific newsfeeds. As another example, a video sharing application 132 may allow a user to view video clips on the client devices 120, where the video clips may be selected for presentation based, at least in part, upon the user's profile or preferences. As yet another example, a news aggregation application 132 may present news articles on the client devices 120, where the news articles may or may not be tailored to the interests of particular users.

Some applications 132 may enable the client devices 120 to also upload content, such as user-created videos and messages. Application updates are yet another cause for application-driven data transfer.

The applications 132-1, 132-2, and 132-M may be supported by application servers 130-1, 130-2, and 130-M (collectively or singularly “130”), respectively, that are accessible to the client devices 120 and the gateway 110 over the remote network 114. The application servers 130 may host content that is sent to or received from users through the corresponding applications 132. For example, an application server 130 may host a library of video content, and items of video content within that library may be selectively sent to users through applications 132 on their client devices 120. An application server 130 may, for example, send application content relating to basketball to a client device 120 of a user that has indicated an interest in basketball.

While one application server 130 is shown for each application 132, it is to be understood that, in some embodiments, a plurality of application servers 130 may support one application 132. Further, in some embodiments, a plurality of applications 132 may be supported by one application server 130. Additionally, the application servers 130 may be implemented as cloud-based services that may be instantiated and disabled based upon the instantaneous volume of requests for application content and user uploads.

Some application content may be delay-tolerant. For example, some newsfeeds (e.g., from social networking applications) may not necessitate real-time delivery and may instead be delayed without noticeably affecting user experience. Accordingly, such content may be conducive to caching. However, the user-specific and often authentication-protected nature of these feeds can make them more difficult to cache, especially within a content delivery network (CDN) that would not have application credentials such as user authentication information.

However, the gateway 110 may be in more direct contact with one or more end users, for example, by being customer premises equipment (CPE) located within the users' home or workplace. The gateway 110 may be connected to the remote network 114 through a connection 112, which may be a digital subscriber line (DSL) connection, a cellular network connection, a powerline communications (PLC) connection, or another type of backhaul connection. The connection 112 may generally be provided, at least in part, by an internet service provider (ISP).

In accordance with the disclosed principles, the gateway 110 may receive authentication information from the client devices 120 through a pairing procedure so that the gateway 110 may act on behalf of the client devices 120 that it services. The gateway 110 may then interact with application servers 130 autonomously from the client devices 120 to prefetch application content as well as to upload content on behalf of the client devices 120.

The gateway 110 may have a plurality of application agents 134 that may each represent a particular application 132 on a particular client device 120. For example, the application agents 134-1 through 134-M may correspond with the applications 132-1 through 132-M, respectively, on the client device 120-1. The other client devices 120-2 through 120-N may have different application agents 134 corresponding to each of their applications 132 (not shown).

Each application agent 134 may interact with a corresponding application server 130 to transfer application content between the application server 130 and a client device 120. The application agents 134 may have the access and ability to use authentication information (e.g., through the pairing process described above) to perform user-specific actions and receive user-specific content, in addition to generic content, on behalf of the client devices 120. As will be described further below, the application agents 134 may use application data storage within or associated with the gateway 110 to cache the application content. Through the application agent's autonomous requests, the gateway 110 may prefetch application content, cache the application content locally, and deliver the application content to one or more client devices 120 at a later time.

The application agents 134 may be aware of the types of content within their associated applications that may be prefetched, delayed for upload, or otherwise handled differently. For example, an application agent 134 for a news aggregation application 132 may avoid caching video news reports or may only cache headlines based on detected or manually-input user preferences.

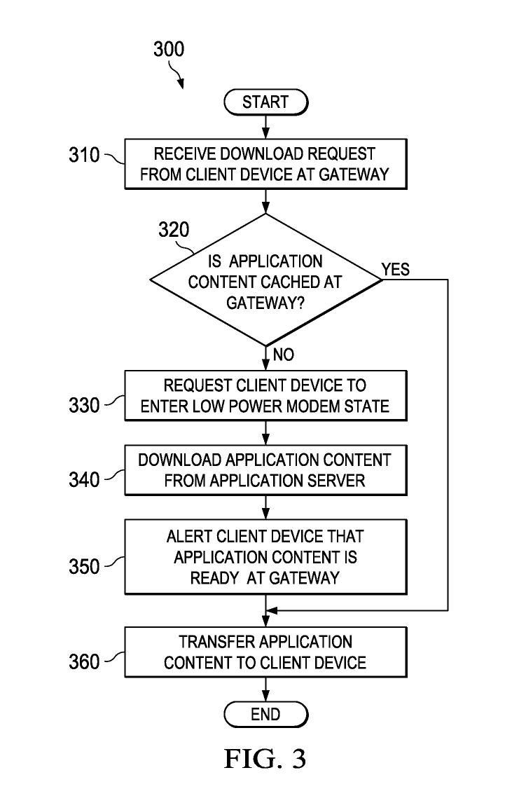

In some embodiments, the gateway 110 may receive content uploaded from an application 132 of a client device 120 and may store this content locally before uploading the content to the related application server 130 at a later time. Accordingly, local storage may enable the gateway 110 to delay user uploads to time periods of increased bandwidth availability (e.g., of the gateway 110 and/or of the related application server 130). This technique may improve network congestion when implemented across many gateways 110 in a networked computing environment. An exemplary process for delaying uploads is described in further detail below with respect to FIG. 4.

In some embodiments, the application agents 134 may operate transparently to the application servers 130 by using the same data-transfer application programming interfaces (API) as mobile applications to interact with the application servers 130, thereby emulating a data transfer API call that may be used by the applications. As a result, requests and data from the application agents 134 on the gateway 110 may appear to the application servers 130 as though they originate from the client devices 120. For example, an application agent 134 corresponding to a social networking application 132 may request for updated, user-specific newsfeeds using the same API call that an application on a client device 120 would use.

In some embodiments, the application agents 134 on the gateway 110 may communicate with one another to determine optimal strategies for transferring data to and from the client devices 120 serviced by the gateway 110. For example, if multiple mobile devices or other client devices 120 each have a common application 132 and an application update is released, a plurality of application agents 134 corresponding to the common application 132 may determine that the same or similar data needs to be sent to each of the client devices 120. The gateway 110 may then form a broadcast network including each of the client devices 120 requiring the update and may send the update data to each client device 120 on the broadcast network substantially simultaneously. The gateway's broadcast network may be implemented as a Long Term Evolution (LTE) broadcast network, a WiFi broadcast network, or using additional or alternative protocols and technologies. Thus, the gateway 110 may efficiently update applications on each client device 120 while reducing local bandwidth consumption (e.g., within the facility having the mobile or other client devices 120 and the gateway 110) as well as external bandwidth consumption (e.g., from an application server 130).

In the case of an application update for multiple identical client devices 120 each having the same previous application revision, the application data corresponding to the update may be identical on each device. However, if the client device 120-1, for example, has a slightly different application revision from the other client devices 120-2 through 120-N, a broadcast approach may be used to deliver the common update content to each client device 120-1 through 120-N, and the gateway 110 may send any incremental update content specifically to the client device 120-1 before or after the broadcast. If the gateway 110 determines that the updates for the client devices 120 are sufficiently different from one another (e.g., such that there is little or no bandwidth saved by broadcasting any common content), the gateway 110 may simply provide the update content to each client device 120 individually.

FIG. 1B shows a schematic diagram illustrating the system 100 of FIG. 1A in more detail. Specifically, FIG. 1B shows exemplary architectures and configurations of the client device 120-1 and the gateway 110 within the system 100. The client devices 120-2 through 120-N may have similar or different internal architectures than the one shown for the client device 120-1 and may perform any of the actions or functionality described herein with respect to the client device 120-1.

The client device 120-1 may comprise a processor 122, a memory device 123, a modem 124, a signal sensor 126, and a location sensor 128. The modem 124 may enable the client device 120-1 to communicate with the gateway 110. For example, the modem 124 may be a wireless modem 124 that sends and receives data on a wireless connection 116-1 shared with the gateway 110. The client device 120-1 and the gateway 110 may communicate over the connection 116-1 using the IEEE 802.11 protocol (WiFi), a cellular protocol (e.g., 4G LTE), or other wireless protocols.

The signal sensor 126 may detect channel characteristics of the connection 116-1 between the client device 120-1 and the gateway 110. For example, the signal sensor 126 may detect the signal strength (e.g., through a received signal strength indicator (RSSI)), the amount of interference (e.g., both as an absolute level and through a signal-to-noise ratio), and the transmission capabilities of the gateway 110. Other channel characteristics include round-trip times of packets between the client device and the gateway as well as round-trip times between the client device and an application server. These channel characteristics may be sent to the client device's processor 122 and/or to the gateway 110 so that one or both of the client device 120-1 and the gateway 110 may alter data transfer strategies (e.g., transmission timings) to balance the energy efficiency of the data transfer with user convenience.

The client device 120-1 may also receive beacons from the gateway 110 through the modem 124, where the beacons comprise encoded extensions conveying resource availability (e.g., computational and network bandwidth) at the gateway 110 as well as bandwidth availability with respect to the application servers 130. This information, which may reflect both present and future availability, may allow the client device 120-1 to better plan when to place upload and download requests to the gateway 110. In some embodiments, such as those where the communication protocol between the client device 120-1 and the gateway 110 does not provide for beacons or beacon extensions, the gateway may instead send the availability information through proprietary packets.

The location sensor 128 may detect the absolute position (e.g., geographical location) or relative position (e.g., with respect to the gateway 110) of the client device 120-1. This information may be used to prioritize, trigger, or otherwise modify transmissions of application content. For example, the gateway 110 may establish a geofence, where the geofence may represent a geographical region around the gateway 110. For example, the geofence may be a circular region centered at the gateway 110 having a two mile radius. The location information from the location sensor 128 may enable the client device 120-1 to alert the gateway 110 when the client device 120-1 enters the geofence and will thus be likely to soon connect with the gateway 110. Upon receiving this alert, the gateway 110 may begin prefetching application content specifically for the client device 120-1, or even for particular applications expected to be used on the client device 120-1, using one or more of the application agents 134 associated with the client device 120-1. Alternatively or additionally, the gateway 110 may begin prefetching the application content when the client device 120-1 enters into communication range of the gateway 110 (e.g., such that the connection 116-1 is established). Upon opening applications on the client device 120-1 when the client device 120-1 is within range of the gateway 110, the user may be quickly and responsively presented with the application content cached at the gateway 110, leading to an improved user experience.

In some scenarios, the client device 120-1 may be outside of the gateway's communication range for an extended period of time. This may cause application content for the client device 120-1 to accumulate on the gateway 110 or may otherwise limit the efficiency of the gateway 110. A threshold period may be established to determine when an alert may be sent to the user, where the threshold period may consider the amount of content accumulated on the gateway 110, the duration of time since the client device 120-1 has last synchronized with the gateway 110, and/or other factors. Once this threshold period is over, the gateway 110 may send an alert to the client device 120-1, which may in turn alert its user to bring the client device 120-1 closer to the gateway 110. For example, the client device 120-1 may use a light emitting diode (LED) to provide the user with visual feedback about the strength of its connection 116-1 to the gateway 110, which may also relate to the client device's proximity to the gateway. The LED may glow a first color (e.g., red) if the client device 120-1 is out of the gateway's communication range, and the LED may transition, either gradually or immediately, to a second color (e.g., green) as or when the client device 120-1 enters into the communication range of the gateway 110. The client device 120-1 may additionally or alternatively use a graphical notification on the screen of the client device 120-1, which may be enabled and triggered by the client device's operating system. In addition or as an alternative to sending an alert, the gateway 110 may implement beamforming to extend the communication range, as described above, if the client device 120-1 has been outside of the communication range for an extended period of time (e.g., beyond the threshold period).

The processor 122 and the modem 124 may be in communication with the memory device 123 having instructions which, when executed, may allow the processor 122 and the modem 124 (and, more generally, the client device 120-1) to perform the actions and functionality described herein.

To save power, the client device 120-1 may have a plurality of power modes, which may affect the client device's processor 122 and/or modem 124. When the client device 120-1 is running a hardware intensive application, the processor 122 may be placed in a high or full power mode. When the client device 120-1 is idle, the processor 122 may be placed in a low-power mode. Similarly, the modem 124 may be placed in a high-power mode when transmitting or receiving data at a high bandwidth and may be placed in a low-power mode when not actively sending or receiving data. When in a low-power mode, the modem 124 may decrease power while still maintaining the connection 116-1 to the gateway 110, so that the client device 120-1 may receive alerts, interrupts, or notifications from the gateway 110, which may prompt the modem 124 to enter into a high-power mode. The processor 122 and the modem 124 may have any number of power modes and may be independently power controlled.

The gateway 110 may comprise a local network modem 150, an external network modem 160, an application processor 140, and network processing units (NPU) 152, 162, which may each be independently power controlled. The gateway 110 may use the local network modem 150 to establish wireless connections 116-1 through 116-N (collectively or singularly “116”) with the client devices 120-1 through 120-N, respectively. The local network modem 150 may provide a cellular, WiFi, and/or other type of networks by which the client devices 120 may connect to the gateway 110. The local network modem 150 may be controlled by the network processing unit 152, which may be aware of the instantaneous quality of each connection 116. For example, the network processing unit 152 may receive and interpret channel characteristic data sensed and sent by the client devices 120 to determine the strength of each connection 116.

The gateway 110 and/or any of the client devices 120 may choose to communicate with one another when the relevant connections 116 are strong (e.g., when they are proximate to one another). This may reduce transmissions times, allowing the client devices 120 to spend more time in low-power modes, thereby saving energy and extending battery life. The network processing unit 152 may also recognize which client devices 120 are connected to the gateway 110, and this determination may be performed even if the application processor 140 is disabled or powered off.

In some embodiments, the local network modem 150 may implement beamforming to increase the connection strength for the mobile devices or other client devices 120 that have pending uploads or downloads and are out of the range normally required (e.g., without beamforming) to efficiently communicate with the gateway 110. A client device's location sensor 128 and/or signal sensor 126 may provide closed-loop feedback to guide a beamforming vector towards the location of the client device 120.

The other network processing unit 162 may control the external network modem 160. The gateway 110 may use the external network modem 160 to communicate with the remote network 114 (e.g., the internet 114) over the connection 112.

As discussed above, mobile applications may provide services that utilize the application servers 130, which may be accessible over the remote network 114. For example, a social network application may have newsfeeds that contain user-specific content pulled from an application server 130. Such content may be delay-tolerant in nature, making it conducive to caching and prefetching techniques. If the gateway 110 knows which applications are installed on the connected client devices 120, the gateway may also determine the corresponding application servers 130 that will commonly be accessed. The network processing unit 162 may determine the time-varying quality of the connections to the application servers 130 (e.g., their available bandwidth) to determine optimal periods for synchronizing the gateway 110 with the application servers 130. This quality data may be organized by time (e.g., time of day, day of week, time of year, etc.) and stored in a table of historical data in a memory device 163 of the network processing unit 162. Through continued operation, the gateway 110 may recognize opportune times for uploading and downloading application content to and from each of the application servers 130 and may convey this information to the client devices 120 through beacons or proprietary packets. In some embodiments, the memory device 163 may comprise a pre-populated table having time-varying quality data associated with the application servers 130. The network processing units 152,162 may also determine periods when real-time client traffic is requested or sent to the client devices 120. Based on local or external bandwidth availability, the gateway 110 may reduce or stop prefetching content and other delay-tolerant processes when the real-time client traffic is detected.

The network processing units 152 and 162 may be in communication with memory devices 153 and 163, respectively, the memory devices 153, 163 having instructions which, when executed, may enable the network processing units 152, 162 to provide the functionality described herein.

The gateway's application processor 140 may have one or more application agents 134 associated with each of the client devices 120. Each application agent 134 may correspond to an application or service that is running on one of the client devices 120. The application agents 134 may be supported by a runtime environment 142 provided by the application processor 140. As described herein, the application processor 140, through the application agents 134, may provide application layer functionality to reduce data transmission energy costs and improve user experience (e.g., by operating at layer 7 of the Open Systems Interconnection (OSI) model). When the application processor 140 and the application agents 134 are disabled, the gateway 110 may continue supporting communication protocols and routing packets through the network processing units 152, 162 (e.g., by operating at layer 3 in the OSI model).

The gateway 110 may receive application credentials such as user identities and log-in information from the client devices 120, and these credentials may be provided to the application agents 134. The application credentials may enable the application agents 134 to place requests, download content, and upload content to their corresponding application servers 130 on behalf of the client devices 120, without the client devices 120 sending explicit instructions to do so. As a result, both data-transfer functions of the client devices 120 and data-serving functions of the application servers 130 may be offloaded to the gateway 110. This may provide the gateway 110 with increased flexibility when servicing the client devices 120. For example, the gateway 110 may delay content uploads to the application servers 130 and downloads to the client devices 120 to decrease energy consumption on the client devices 120 while balancing usability.

The application processor 140 may be in communication with a memory device 144 having instructions which, when executed, may enable the application processor 140 to provide the functionality described herein.

The application processor 140 may be in further communication with application data storage 148 which may cache application content for the gateway 110. For example, the application data storage 148 may store prefetched application content that is requested by the gateway 110 before the application content is requested by one or more of the client devices 120. The application content may not need to be translated into renderable web objects like content that is typically cached on gateways. Instead, the application content may be stored in propriety formats that are generally reserved for the mobile applications (e.g., as binary files), allowing for more efficient data transfer. The application data storage 148 may also store content uploaded by the client devices 120 to the gateway 110 while the gateway 110 waits for an opportune time to upload the content to an application server 130. The application data storage 148 may be segmented for each client device and/or user to provide data security and privacy.

The application processor 140 may be in further communication with configuration storage 146, which may store synchronization policies that guide the gateway's behavior. For example, the synchronization policies may determine the periodicity by which each application agent 134 may sync with a related application server 130 to download new application content from the application server 130 and to upload user content to the application server 130. In some embodiments, the uploads and downloads may be decoupled from one another and separately configured. The synchronization policies may also determine the periodicity or specific times when the application agents 134 may push application content to the client devices 120.

In some embodiments, a user may manually configure and change the synchronization policies within the configuration storage 146. For example, the user may set synchronization policies to selectively synchronize application content for a subset of the applications on a client device 120 when the client device 120 enters the gateway's range. The user may place applications into prioritization groups, create an ordered list of the applications establishing relative priority, and/or assign priorities to the applications using other structures and techniques. The user may also establish the periodicity of the synchronization (e.g., between the client devices 120 and the gateway 110 as well as between the gateway 110 and the application servers 130). The client devices 120 may also be prioritized with respect to one another.

Some synchronization policies may be limited to certain time periods (e.g., times of the day, week, or year) to provide an even higher granularity of control. For example, users may explicitly request that content for some applications is synchronized more or less frequently on certain days of the week. Other synchronization policies may be time-agnostic (e.g., always applicable).

In some embodiments, the synchronization policies may adapt automatically to user behavior. For example, if a mobile device or other client device 120 is known to request application content associated with an application at approximately a particular time of day, the synchronization policy may adapt such that the corresponding application agent on the gateway 110 requests and receives the application content from an application server 130 (e.g., via the external network modem 160) shortly before the client device 120 is expected to request the application content from the gateway 110. Accordingly, the synchronization policies may adapt to match a user's schedule.

The synchronization policies may also consider historical and predicted loads and/or bandwidth availabilities of the application servers 130, so that the application agents 134 may request content from the servers during non-peak times. Accordingly, the gateway 110 may balance network cost efficiency with user convenience. Through user manipulation of the synchronization policies and/or automatic adaptation based on user behavior, the gateway 110 may enable the user to have input into this balance.

The synchronization policies may also determine the amount of storage space available for each application agent 134 to cache prefetched content and the types of application content that may be cached. For example, a synchronization policy may allow an application agent 134 corresponding to a news application to cache headlines and cover pages but not subsequent pages, audio content, or video content. As discussed above, synchronization policies may be time-variant, thereby allowing application agents 134 to more aggressively prefetch application content before expected periods of heavy application usage.

While certain figures may be described in the context of mobile applications and mobile devices, the disclosed principles may also be applied to other types of client devices, such as desktop workstations. Many mobile applications have corresponding non-mobile (e.g., desktop) applications, which may also be compatible with application agents 134 on the gateway 110. Further, mobile applications and their non-mobile counterparts are increasingly converging to common runtime environments, which may allow mobile and non-mobile applications to share application content cached at the gateway 110.

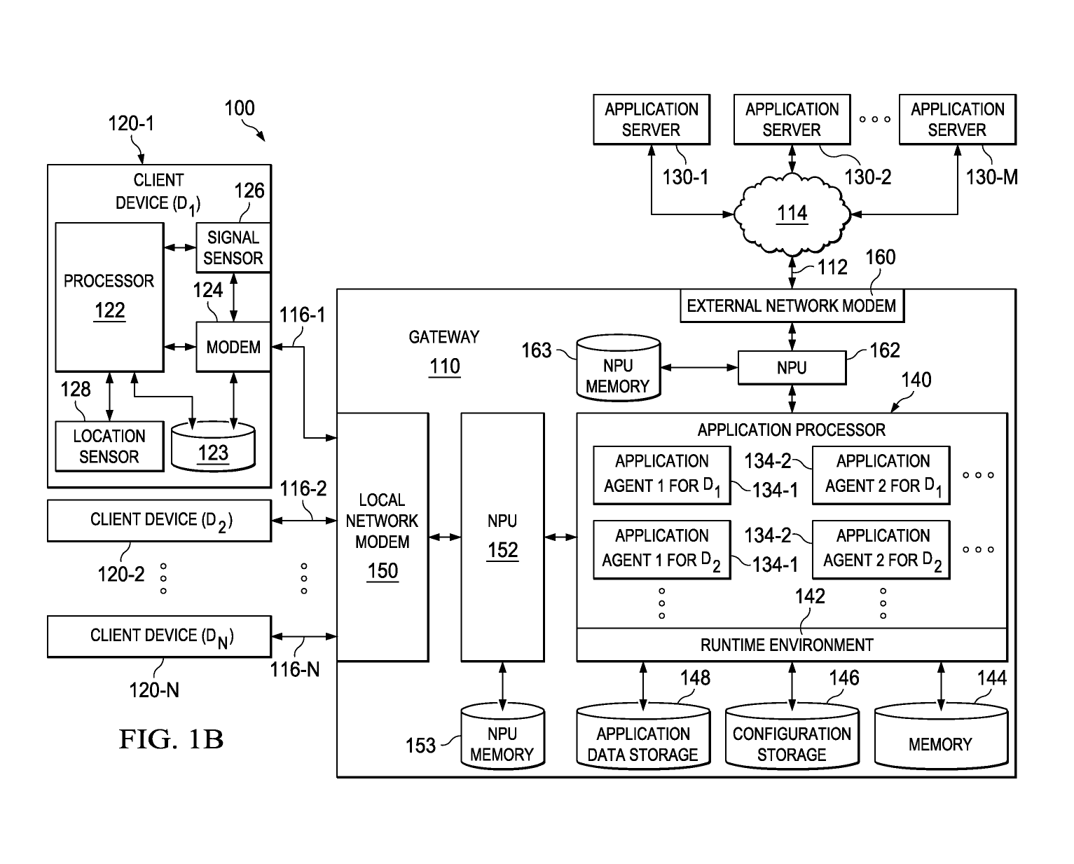

FIG. 2 shows a flowchart illustrating an exemplary process 200 for prefetching application content to be cached on a gateway 110. Referring to the exemplary system architecture of FIGS. 1A-1B, the process 200 may be implemented for multiple client devices 120 associated with the gateway 110 in a parallel or sequential manner.

At an action 210, the gateway 110 may determine which of a mobile device's or other client device's applications 132 are supported by the gateway 110. For example, the gateway 110 may have a preinstalled set of application agents 134 that may support corresponding applications 132 on the client device 120. In some embodiments, the gateway 110 may also be configured to connect to an online repository of application agents (e.g., similar to a mobile application store) and check which of the client device's applications 132 have corresponding application agents 134. The gateway 110 may install and/or instantiate the application agents 134 that are compatible with applications 132 on the client device 120.

At an action 220, the gateway 110 may receive application credentials for each of the compatible applications 132 and may associate each set of application credentials with the respective application agent 134. The application credentials may, for example, be a username and password, an encryption key, a digital certificate, or other types of information that enables the application agents 134 on the gateway 110 to communicate with an application server 130 on behalf of a mobile application 132 and user.

At an action 230, the gateway 110 may, through the application agent 134, request application content from the application server 130 on behalf of the user and the application 132. The application agent 134 may place the request using the same application programming interface call(s) to the application server 130 as the mobile application 132 would. Accordingly, the gateway 110 may be transparent to the application server 130.

The gateway 110 may wait to perform the content request of the action 230 until a time when either or both of the application server 130 and the gateway 110 have relatively high bandwidth availability, such that the process 200 helps balance network traffic locally and/or globally. The gateway 110 may additionally or alternatively wait to perform the content request of the action 230 based on historical user behavior and predicted user behavior. For example, if the gateway 110 recognizes that the user generally checks a newsfeed of the application 132 before a particular time each day, the gateway 110 may request the content shortly before it is expected to be consumed by the user.

At an action 240, the gateway 110 may receive and cache the content in a local application data storage 148. The cached content may be stored in a proprietary format (e.g., as a binary file) that may be native to the application 132 on the client device 120. This format may provide increased data compression with respect to the web renderable content that may be cached by gateways. Accordingly, less time and/or bandwidth may be required when delivering the application content to the client device 120.

At an action 250, the gateway 110 may transmit the application content to the client device 120. The application content may be transmitted, for example, after being requested by the application 132 on the client device 120. Alternatively, if the gateway 110 determines that the application content will likely be consumed and if the client device 120 has available memory, the gateway 110 may push the application content to the client device 120 during a time when the gateway 110 has a strong connection 116 with the client device 120. While this technique may increase memory utilization on the client device 120, it may also reduce energy consumption on the client device 120. That is, the strong connection 116 may enable the data to be transmitted over a shorter period of time than would otherwise be required, which allows the client device 120 to more quickly switch its modem 124 back to a low-power mode (or even off).

In some scenarios, cached content in the application data storage 148 may never be requested or sent to the client device 120 and may simply be phased out of the application data storage 148 through an expiration timer or by being overwritten by more current data.

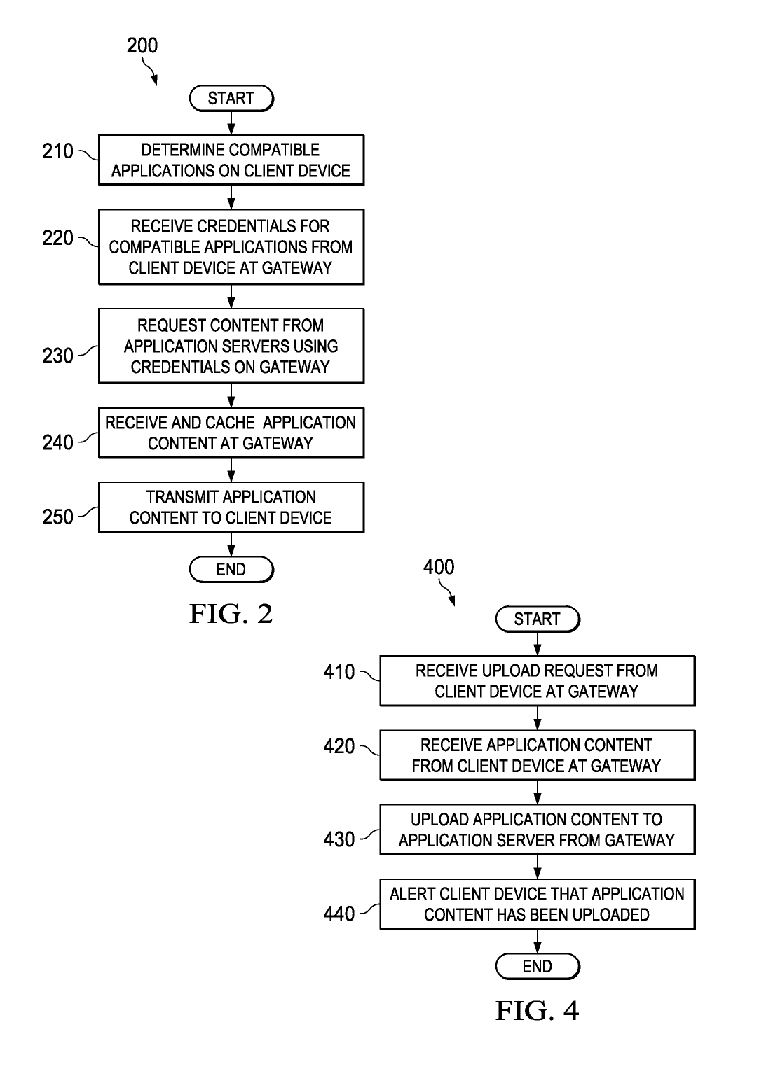

FIG. 3 shows a flowchart illustrating an exemplary process 300 for managing download requests from a client device 120 at a gateway 110. Referring to the exemplary system architecture of FIGS. 1A-1B, the process 300 may be implemented for multiple client devices 120 associated with the gateway 110 in a parallel or sequential manner. At an action 310, the gateway 110 may receive a request for application content from the client device 120. The request may be interpreted by an application agent 134 on the gateway 110 corresponding to the application 132 on the client device 120. The request may contain priority or urgency information that may determine the amount of flexibility that the application agent 134 has in processing the request and retrieving the requested application content.

At an action 320, the gateway 110 (e.g., through the application agent 134) may determine whether or not the requested application content is cached in local application data storage 148. If the requested application content is cached, the gateway 110 may transfer the application content to the client device 120 at an action 360 and the process 300 may complete. If the requested application content is not cached, the process 300 may continue to an action 330.

At the action 330, the gateway 110 may request the client device 120 to change its modem 124 to a low-power mode. This would enable the client device 120 to conserve power while the gateway 110 attempts to procure the requested application content. With its modem 124 in the low-power mode, the client device 120 may not be capable of engaging with the gateway 110 in application data transfer but may listen for a “wake up” signal or interrupt signal that instructs the client device's modem 124 to enter a high-power mode.

At an action 340, the gateway 110 may download the requested application content from the application server 130. The timing or delay of the action 340 may vary based on the priority information provided in the request received at the action 310. For example, if the client device 120 places a higher priority on the request, the gateway 110 may attempt to download the content soon (or even substantially immediately) after receiving the request.

After the gateway 110 completes downloading the requested content from the application server 130, the gateway 110 may alert the client device 120 at an action 350. For example, the gateway 110 may send a “wake up” signal that instructs the client device 120 to turn on its modem 124.

At the action 360, the gateway 110 may transmit the application content to the client device 120. The client device's modem 124 may subsequently enter a low-power mode or may remain in a high-power mode (e.g., to request additional application data from the gateway 110).

FIG. 4 shows a flowchart illustrating an exemplary process 400 for managing upload requests from a mobile device or other client device 120 at a gateway 110. Referring to the exemplary system architecture of FIGS. 1A-1B, the process 400 may be implemented for multiple client devices 120 associated with the gateway 110 in a parallel or sequential manner. At an action 410, the gateway 110 may receive a request to upload content from the client device 120. The request may also include priority information that may be used to determine when the gateway 110 should upload the application content to an application server 130. The gateway 110 may respond to the client device 120 when it is ready to receive the application content, which may be substantially immediately after receiving the request.

At an action 420, the gateway 110 may receive the application content from the client device 120. The application content may be stored at the gateway 110 in local application data storage 148 instead of being immediately uploaded to the application server 130.

In many networked computing environments, the bandwidth within a local area network is much greater than the bandwidth to a server on a remote network, even if the local area network comprises wireless connections. Additionally, the latency between the gateway 110 and the client device 120 may be much shorter than the latency between the client device 120 and an application server 130. For file transfer using the feedback-sensitive Transmission Control Protocol (TCP), the reduced latency may result in reduced round trip times for sending packets from the client device 120 and receiving confirmation that the packets have been received.

Due to at least the factors described above, the total time to upload content from the client device 120 to the gateway 110 may be shorter than if the client device 120 were to directly upload the content to the application server 130 (e.g., without caching at the gateway 110). Because the client device's upload transmission time may be decreased, the client device 120 may save power by maintaining its modem 124 (e.g., a WiFi radio) in a high-power mode for a shorter period of time.

Depending on the priority information associated with the uploaded content, the gateway 110 may hold the content in the application data storage 148 until a non-peak period for the application server 130 and/or the gateway 110 before proceeding to an action 430.

At the action 430, the gateway 110 may upload the application content stored in the application data storage 148 to the application server 130.

At an action 440, the gateway 110 may alert the client device 120 that the content has been uploaded to the application server 130. The client device 120 may then provide feedback to the user indicating the successful upload. In some embodiments where user notification is not implemented, the gateway 110 may not issue an alert, and the client device 120 may simply accept that its portion of the process 400 is completed after the client device 120 uploads the content to the gateway 110 at the action 420.

The actions shown in the processes 200, 300, and 400 of FIGS. 2, 3, and 4, respectively, may not necessarily take place in the presented order. In some embodiments, more, fewer, or different actions may be implemented to perform any of these processes. For example, in some embodiments, client devices 120 may not be requested to enter a low power modem state. The processes 200, 300, and 400 may be readily adapted by one of ordinary skill in the art based on the design requirements of a particular network.

While various embodiments in accordance with the disclosed principles have been described above, it should be understood that they have been presented by way of example only, and are not limiting. Thus, the breadth and scope of the disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It is contemplated that the network processing units, application processors, modems, sensors and other elements be provided according to the structures disclosed herein in integrated circuits of any type to which their use commends them, such as ROMs, RAM (random access memory) such as DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as digital signal processors (DSP), graphics system processors (GSP), synchronous vector processors (SVP), and image system processors (ISP) all represent sites of application of the principles and structures disclosed herein.

Memory devices such as application data storage and configuration storage may store any suitable information. Memory devices may comprise any collection and arrangement of volatile and/or non-volatile components suitable for storing data. For example, memory devices may comprise random access memory (RAM) devices, read only memory (ROM) devices, magnetic storage devices, optical storage devices, and/or any other suitable data storage devices. In particular embodiments, memory devices may represent, in part, computer-readable storage media on which computer instructions and/or logic are encoded. Memory devices may represent any number of memory components within, local to, and/or accessible by a processor.

Implementation is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

Networked computing environments such as local area networks and remote networks described in the present application may include, but are not limited to, computing grid systems, distributed computing environments, cloud computing environment, etc. Such networked computing environments include hardware and software infrastructures configured to form a virtual organization comprised of multiple resources which may be in geographically disperse locations.

Various terms used in the present disclosure have special meanings within the present technical field. Whether a particular term should be construed as such a “term of art” depends on the context in which that term is used. “Connected to,” “in communication with,” “associated with,” or other similar terms should generally be construed broadly to include situations both where communications and connections are direct between referenced elements or through one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “immediately,” “equivalent,” “during,” “complete,” “identical,” and the like should be understood to mean “substantially at the time,” “substantially immediately,” “substantially equivalent,” “substantially during,” “substantially complete,” “substantially identical,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the subject matter set forth in any claims that may issue from this disclosure. Specifically and by way of example, although the headings refer to a “Field of the Disclosure,” such claims should not be limited by the language chosen under this heading to describe the so-called technical field. Further, a description of a technology in the “Background” is not to be construed as an admission that technology is prior art to any subject matter in this disclosure. Neither is the “Summary” to be considered as a characterization of the subject matter set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method for synchronizing content between an application server and an application on a client device, the method comprising:
receiving, by a gateway in communication with the client device, application credentials for the application on the client device,
wherein the application credentials enable the gateway to autonomously make requests on behalf of the client device;
requesting, by the gateway, application content from the application server using the application credentials;
receiving, at the gateway, the requested application content; and
transmitting, by the gateway, the requested application content to the client device when the client device is within a range of the gateway.

2. The method of claim 1, further comprising:
storing, by application data storage associated with the gateway, the requested application content after the requested application content is received by the gateway.

3. The method of claim 1:
wherein the gateway comprises an application processor supporting an application agent; and
wherein the application agent requests the application content through a data transfer application programming interface (API) call that emulates a data transfer API call that may be made by the application on the client device.

4. The method of claim 1, wherein the requesting, by the gateway, of the application content is triggered by the gateway detecting that the client device has entered the range of the gateway.

5. The method of claim 1, wherein the requesting, by the gateway, of the application content is triggered by the gateway detecting that the client device has entered a geofence of the gateway, the geofence representing a geographical region around the gateway.

6. The method of claim 1, wherein the requesting, by the gateway, of the application content is triggered by a synchronization policy stored by the gateway.

7. The method of claim 6, wherein the synchronization policy enables the gateway to request the application content from the application server during a time period of non-peak traffic.

8. The method of claim 1, further comprising:
sending an alert to the client device after receiving the requested application content or after detecting that the client device has not been within the range of the gateway for a time period exceeding a threshold period.

9. The method of claim 8, wherein the gateway implements beamforming to extend the range and deliver the application content to the client device in response to detecting that the client device has not been within the range of the gateway for the time period exceeding the threshold period.

10. The method of claim 1, further comprising:
creating, by the gateway, a broadcast network to deliver the application content to a plurality of client devices within the range of the gateway.

11. The method of claim 10, wherein the application content is an update to applications on the plurality of client devices.

12. The method of claim 10, wherein the broadcast network is one of a Long Term Evolution (LTE) broadcast network and a WiFi broadcast network.

13. The method of claim 1, further comprising:
sending, by the gateway, a beacon to the client device,
wherein the beacon conveys resource availability of the gateway to the client device.

14. The method of claim 13, wherein the beacon further conveys bandwidth availability of the application server to the client device.

15. A gateway for synchronizing content between an application server and an application on a client device, the gateway comprising:
a first modem in communication with the client device, the first modem configured to receive application credentials for the application on the client device,
wherein the application credentials enable the gateway to autonomously make requests on behalf of the client device;
a second modem configured to request application content from the application server using the application credentials, the second modem further configured to receive the requested application content from the application server,
wherein the first modem is further configured to transmit the requested application content to the client device when the client device is within a range of the gateway.

16. The gateway of claim 15, further comprising:
application data storage configured to store the requested application content after the requested application content is received by the gateway.

17. The gateway of claim 15, further comprising:
an application processor configured to support an application agent,
wherein the application agent is configured to request the application content through a data transfer application programming interface (API) call that emulates a data transfer API call that may be made by the application on the client device.

18. The gateway of claim 15, wherein the first modem is further configured to send a beacon to the client device, the beacon configured to convey resource availability of the gateway to the client device.

19. The gateway of claim 18, wherein the beacon is further configured to convey bandwidth availability of the application server to the client device.

20. The gateway of claim 15, further comprising:
configuration storage to store a synchronization policy,
wherein the synchronization policy establishes a time when the second modem requests the application content from the application server.

21. The gateway of claim 20, wherein the synchronization policy enables the gateway to request the application content from the application server during a time period of non-peak traffic.

22. A gateway for synchronizing content between an application server and an application on a client device, the gateway comprising:
means for receiving application credentials for the application on the client device at the gateway,
wherein the application credentials enable the gateway to autonomously make requests on behalf of the client device;
means for requesting application content from the application server using the application credentials;
means for receiving the requested application content; and
means for transmitting the requested application content to the client device when the client device is within a range of the gateway.

23. The gateway of claim 22, further comprising means for storing the requested application content after the requested application content is received by the gateway.

24. The gateway of claim 22, further comprising means for requesting the application content from the application server while emulating the application on the client device.

25. The gateway of claim 22, further comprising means for conveying resource availability of the gateway to the client device.

26. The gateway of claim 22, further comprising means for conveying bandwidth availability of the application server to the client device.

27. The gateway of claim 22, further comprising means for requesting the application content from the application server during a time period of non-peak traffic.

28. A method for synchronizing content from an application server through a gateway, the method comprising:
sending, by a client device in communication with the gateway, application credentials for an application on the client device,
wherein the application credentials enable the gateway to autonomously make requests for application content from the application server on behalf of the client device;
requesting, by the client device, the application content after the application content has been stored on the gateway when the client device is within a range of the gateway; and
receiving, at the client device, the requested application content.

29. The method of claim 28, further comprising:
alerting a user of the client device to move the client device closer to the gateway in response to a determination that the client device has not been within the range of the gateway for a time period exceeding a threshold period.

30. The method of claim 29, further comprising:
wherein the alerting of the user comprises providing visual feedback to the user about the client device's connection or proximity to the gateway.
